(19) United States
(12) Patent Application Publication
(10) Pub. No.: US 2011/0305397 A1
(43) Pub. Date: Dec. 15, 2011

(54) Systems and methods for retargeting an image utilizing a saliency map

(76) Inventors: Robinson Piramuthu, Oakland, CA (US); Daniel Prochazka, Pacifica, CA (US)

(21) Appl. No.: 12/932,927

(22) Filed: Mar. 8, 2011

Related U.S. Application Data
(60) Provisional application No. 61/339,572, filed on Mar. 8, 2010.

(51) Int. Cl. G06K 9/48

(52) U.S. Cl. 382/199

(57) ABSTRACT

Systems for retargeting an image utilizing a saliency map are disclosed, with methods and processes for making and using the same. To create a contextually personalized presentation, an image may be presented within a target area. The desired location within the target area may be determined for the displaying of the salient portions of the image. To expose the image optimally, the image may need to be transformed or reconfigured for proper composition. Aspect ratios of images may be altered with preservation of salient regions and without distorting the image. A quality function is presented to rate target areas available for personalized presentations.

### CROSS REFERENCE TO RELATED APPLICATION

This application claims priority to U.S. provisional patent Application No. 61/339,572, filed Mar. 8, 2010, which is hereby incorporated by reference herein in its entirety.

### BACKGROUND OF THE INVENTION

Images have been utilized to capture precious moments since the advent of the photograph. With the emergence of the digital camera, an unimaginable number of photographs are captured every day. Certain precious moments have significant value to a particular person or group of people, such that photographs of a precious moment are often selected for a personalized presentation. For example, greeting card makers now allow users to edit, configure, or otherwise personalize their offered greeting cards, and a user will likely put in a photograph of choice to add their personal touch to a greeting card. Items that may be used for creating a personalized presentation abound, such as t-shirts, mugs, cups, hats, mouse-pads, other print-on-demand items, and other gift items and merchandise. Personalized presentations may also be created for sharing or viewing on certain devices, uploading to an online or offline location, or otherwise utilizing computer systems. For example, personalized presentations may be viewed on desktop computers, laptop computers, tablet user devices, smart phones, or the like, through online albums, greeting card websites, social networks, offline albums, or photo sharing websites.

Many applications exist for allowing a user to provide context to a photograph for providing a humorous, serious, sentimental, or otherwise personal message. Online photo galleries allow their customers to order such merchandises by selecting pictures from their albums. Kiosks are available at big retail stores all around the world to address similar needs. However, there is no automated approach to position the photograph inside the contextual region. This must be done by the user manually or an arbitrary position is accepted. In some situations, specialized personnel are hired to position the images offline. This reduces the bandwidth of the system to cater to customer needs, especially during holiday seasons.

Another hindrance to the creation of personalized presentations is the inability of current systems to present users with a number of contextual solutions that will provide good composition of a photograph. For example, a user may want to select a contextual template for a photograph at a kiosk or from an online photo gallery. But there may be hundreds of templates available with the same theme (e.g. Season Greetings) even though only a select few templates may provide a good composition of the photograph. Currently the user is forced to go through the collection of templates on by one to determine which works best for displaying a proper composition of the image and for conveying the personalized presentation.

At times, users wish to change the aspect ratio of a selected photograph without losing the portions of the image that possess the precious moment or significant value. For example, a digitally stored photograph may have a fixed aspect ratio. The aspect ratio is usually changed however, when the image is transferred to another form of media. A common example is for photo prints. Print sizes vary but the pictures are stored at a fixed or limited set of aspect ratios by a digital camera. When a user orders printing of numerous pictures from an online photo gallery, care must be taken so that the important regions are not cropped away. The same concerns apply for digital photo frames that present an image in only a certain ratio. Current standard approaches in the photo industry have a high risk of cropping away salient regions unless the salient regions are centered in the photograph. Other popular image retargeting approaches such as Seam Carving (“Seam Carving for Content-Aware Image Resizing”, S. Avidan, A. Shamir, ACM Transactions on Graphics, Vol. 26, Issue 3, Article 10, July 2007), change the proportions of different regions in the image, thereby distorting the image which is usually unacceptable to the user.

As should be apparent, there are needs for solutions that provide users with faster or automated abilities for creating contextually personalized presentations of their images, correct and relevant options for the images chosen to be personalized, and correctly crop images for a given aspect ratio without distortion.

### SUMMARY

The following presents a simplified summary of the disclosure in order to provide a basic understanding to the reader. This summary is not an extensive overview of the disclosure and it does not identify key or critical elements of the embodiments disclosed nor delineate the scope of the disclosed embodiments. Its sole purpose is to present some concepts disclosed herein in a simplified form as a prelude to the more detailed description that is presented later.

Creating contextually personalized presentations with images embedded creates the inherent problem of determining placement of the image within the target area of the available options. By defining parameters of the salient regions of the image, the target area for the placement of the image, and converting the image such that proper composition is achieved, the problem is resolved.

In one embodiment, the desired placement within the target area is determined, the salient region of the image is known or provided, image transformation parameters for exposing the salient regions optimally through the target area are determined, and the image is reconfigured accordingly for proper composition. In another embodiment, a position bias map is utilized to locate the desired location.

In an alternative embodiment, the desired location and the salient regions with the image as a whole are considered to create a composition quality score to enable the ranking of one target area compared to another or others.

In another alternative embodiment, the target area is a known aspect ratio that is different from the aspect ratio of the original image. By utilizing the salient regions of the original image and a composition quality function, the aspect ratio can be manipulated to the desired target area's aspect ratio with proper composition.

### BRIEF DESCRIPTION OF DRAWINGS

The accompanying drawings, which are included as part of the present specification, illustrate the presently preferred embodiments and together with the general description given above and the detailed description of the preferred embodiments given below serve to explain and teach the principles of the disclosed embodiments.

FIG. 1 is a diagrammatic illustration of a system, process or method for retargeting an image utilizing a saliency map, according to one embodiment.

FIG. 2 is a diagrammatic illustration of a system, process or method for sorting target areas within templates for an image, according to another embodiment.

FIG. 3 is sample color image presented in gray scale utilized to illustrate the processes and sub-processes of the exemplary embodiments disclosed herein.

FIG. 4 is a sample greeting card template presented in gray scale utilized to illustrate the processes and sub-processes of the exemplary embodiments disclosed herein.

FIG. 5 is a sample improper composition of the image in FIG. 3 into the target area of the template in FIG. 4.

FIG. 6 is a sample proper composition of the image in FIG. 3 into the target area of the template in FIG. 4.

FIG. 7 is a sample transparency map created from the sample greeting card template in FIG. 4.

FIG. 8 is an illustration in gray scale for the horizontal bias term of the target area within the sample greeting card template in FIG. 4.

FIG. 9 is an illustration in gray scale for the vertical bias term of the target area within the sample greeting card template in FIG. 4.

FIG. 10 is an illustration in gray scale of the effective bias term from contribution by the product of the horizontal bias term of FIG. 8 and the vertical bias term of FIG. 9.

FIG. 11 is an illustration in gray scale of the effective bias term when γ_{c}=0. Better results may be achieved when γ_{c}<0.

FIG. 12 is the sample image in FIG. 3 with face rectangles over the two faces.

FIG. 13 is an illustration of the salient region Rₛ from the sample image in FIG. 3.

FIG. 14 is an illustration of the overall saliency map created from the assumption that the face portion of the salient region Rₛ has a higher saliency than the rest of the region.

FIG. 15 is the overall saliency map illustrated in FIG. 14 with the input image's transparency controlled by the saliency map.

FIG. 16 is an illustration in gray scale of the transformed saliency map S_{T(I)}(x,y) overlapped with the target region transparency α_{c}(x, y).

FIG. 17 is an illustration of an exemplary embodiment of architecture 1000 of a computer system suitable for executing the methods disclosed herein.

It should be noted that the figures are not drawn to scale and that elements of similar structures or functions are generally represented by like reference numerals for illustrative purposes throughout the figures. It also should be noted that the figures are only intended to facilitate the description of the preferred embodiments of the present disclosure. The figures do not illustrate every aspect of the disclosed embodiments and do not limit the scope of the disclosure.

### DETAILED DESCRIPTION

Systems for retargeting an image utilizing a saliency map are disclosed, with methods and processes for making and using the same.

In the following description, for purposes of explanation, specific nomenclature is set forth to provide a thorough understanding of the various inventive concepts disclosed herein. However it will be apparent to one skilled in the art that these specific details are not required in order to practice the various inventive concepts disclosed herein.

Some portions of the detailed description that follow are presented in terms of processes and symbolic representations of operations on data bits within a computer memory. These process descriptions and representations are the means used by those skilled in the data processing arts to most effectively convey the substance of their work to others skilled in the art. A process is here, and generally, conceived to be a self-consistent sequence of sub-processes leading to a desired result. These sub-processes are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “locating” or “finding” or the like, may refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission, or display devices.

The disclosed embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk, including floppy disks, optical disks, CD-ROMS, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct more specialized apparatus to perform the required method sub-processes. The required structure for a variety of these systems will appear from the description below. In addition, the disclosed embodiments are not described with reference to any particular programming language. It will be appreciated that a variety of programming languages may be used to implement the teachings of the disclosed embodiments.

In some embodiments an image is a bitmapped or pixmapped image. As used herein, a bitmap or pixmap is a type of memory organization or image file format used to store digital images. A bitmap is a map of bits, a spatially mapped array of bits. Bitmaps and pixmaps refer to the similar concept of a spatially mapped array of pixels. Raster images in general may be referred to as bitmaps or pixmaps. In some embodiments, the term bitmap implies one bit per pixel, while a pixmap is used for images with multiple bits per pixel. One example of a bitmap is a specific format used in Windows that is usually named with the file extension of .BMP (or .DIB for device-independent bitmap). Besides BMP, other file formats that store literal bitmaps include InterLeaved Bitmap (ILBM), Portable Bitmap (PBM), X Bitmap (XBM), and Wireless Application Protocol Bitmap (WBMP). In addition to such uncompressed formats, as used herein, the term bitmap and pixmap refers to compressed formats. Examples of such bitmap formats include, but are not limited to, formats, such as JPEG, TIFF, PNG, and GIF, to name just a few, in which the bitmap image (as opposed to vector images) is stored in a compressed format. JPEG is usually lossy compression. TIFF is usually either uncompressed, or losslessly Lempel-Ziv-Welch compressed like GIF. PNG uses deflate lossless compression, another Lempel-Ziv variant. More disclosure on bitmap images is found in Foley, 1995, Computer Graphics: Principles and Practice, Addison-Wesley Professional, p. 13, ISBN 0201848406 as well as Pachghare, 2005, Comprehensive Computer Graphics: Including C++, Laxmi Publications, p. 93, ISBN 8170081858, each of which is hereby incorporated by reference herein in its entirety.

In typical uncompressed bitmaps, image pixels are generally stored with a color depth of 1, 4, 8, 16, 24, 32, 48, or 64 bits per pixel. Pixels of 8 bits and fewer can represent either grayscale or indexed color. An alpha channel, for transparency, may be stored in a separate bitmap, where it is similar to a greyscale bitmap, or in a fourth channel that, for example, converts 24-bit images to 32 bits per pixel. The bits representing the bitmap pixels may be packed or unpacked (spaced out to byte or word boundaries), depending on the format. Depending on the color depth, a pixel in the picture will occupy at least n/8 bytes, where n is the bit depth since 1 byte equals 8 bits. For an uncompressed, packed within rows, bitmap, such as is stored in Microsoft DIB or BMP file format, or in uncompressed TIFF format, the approximate size for a n-bit-per-pixel (2n colors) bitmap, in bytes, can be calculated as: size≈width×height×n/8, where height and width are given in pixels. In this formula, header size and color palette size, if any, are not included. Due to effects of row padding to align each row start to a storage unit boundary such as a word, additional bytes may be needed.

In computer vision, segmentation refers to the process of partitioning a digital image into multiple regions (sets of pixels). The goal of segmentation is to simplify and/or change the representation of an image into something that is more meaningful and easier to analyze. Image segmentation is typically used to locate objects and boundaries (lines, curves, etc.) in images.

The result of image segmentation is a set of regions that collectively cover the entire image, or a set of contours extracted from the image. Each of the pixels in a region share a similar characteristic or computed property, such as color, intensity, or texture. Adjacent regions are significantly different with respect to the same characteristic(s).

Several general-purpose algorithms and techniques have been developed for image segmentation. Exemplary segmentation techniques are disclosed in The Image Processing Handbook, Fourth Edition, 2002, CRC Press LLC, Boca Raton, Fla., Chapter 6, which is hereby incorporated by reference herein for such purpose. Since there is no general solution to the image segmentation problem, these techniques often have to be combined with domain knowledge in order to effectively solve an image segmentation problem for a problem domain.

Throughout the present description of the disclosed embodiments described herein, all steps or tasks will be described using this one or more embodiment. However, it will be apparent to one skilled in the art, that the order of the steps described could change in certain areas, and that the embodiments are used for illustrative purposes and for the purpose of providing understanding of the inventive properties of the disclosed embodiments.

The following notations and terms are utilized within:

Dimension of an image: The dimension of an image may be described by the number of rows (“# rows”) by (“×”) the number of columns (“# columns”). For example, a “1500×1000” images has 1500 rows and 1000 columns of pixels.

“Aspect ratio” of image is the ratio of height (“h”) to width (“w”) of the image. If the image is of dimensions h×w, the aspect ratio for the image may be defined to be h/w or h:w. For example, aspect ratio of a “1500×1000” image may be written as 1500/1000 which equals 1.5 or 1500:1000 or 3:2.

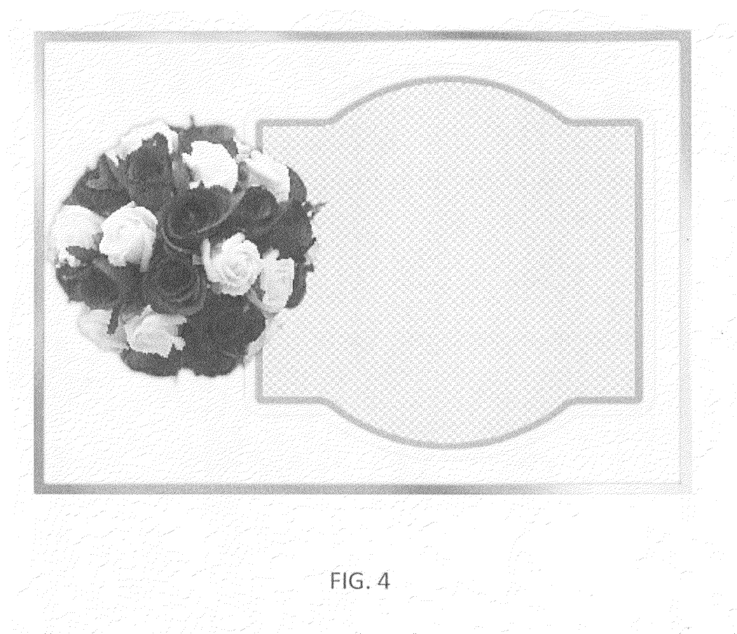

“Target area” may refer to the region of a contextually personalized presentation option provided for composition of the image. For example, the target area may be the “cut-out” region of a greeting card template or other templates provided for t-shirts, mugs, cups, hats, mouse-pads, other print-on-demand items, and other gift items and merchandise. A template may also apply to online viewing options. FIG. 4 is a sample greeting card template presented in gray scale utilized to illustrate the processes and sub-processes of the exemplary embodiments disclosed herein. Within the target area, a “desired location” (sometimes referred to as “position bias map” or “desired placement”) for the salient region may need to be provided, located or determined.

“Salience” or “salient” may refer to something that is considered, subjectively or objectively, relevant, or germane, or important, or prominent, or most noticeable, or otherwise selected.

“Crop-safe rectangle” refers to the smallest rectangle that captures the salient regions in an image.

As mentioned before in the Background of the Invention section above, there are a number of different ways that photographs or images may be utilized to create personalized presentations. One such technique is to find or determine a proper location for an image within a target area. In one embodiment, a photograph or an image and a template are selected or provided to be utilized to create a personalized presentation. The personalized presentation is desired to result in the image placed properly within the area designated (or target area) of the template. The image may be properly placed if the composition of the image within the template results such that the portions or areas of the image that are either selected or considered salient are visible.

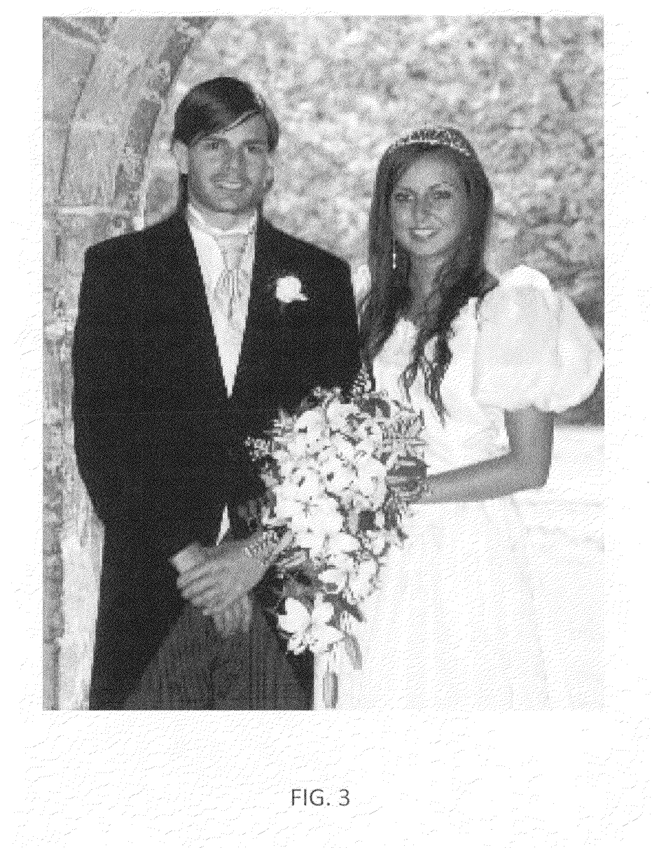

For example, FIG. 3 is sample color image presented in gray scale utilized to illustrate the processes and sub-processes of the exemplary embodiments disclosed herein. The salient regions of the image found in FIG. 3 may be a number of different items or combination of items. The following are different, but not limiting, examples of different interpretations of salient portions of the image: (1) a florist may find that the flowers held by the female are the most pertinent portion of the image; (2) the family of the female in the image may determine that she is the most relevant portion of the image; (3) the family of the male in the image may determine that he is the most important portion of the photograph; or, (4) the male and female in the image may determine that, together, they both are the most germane portions of the photograph.

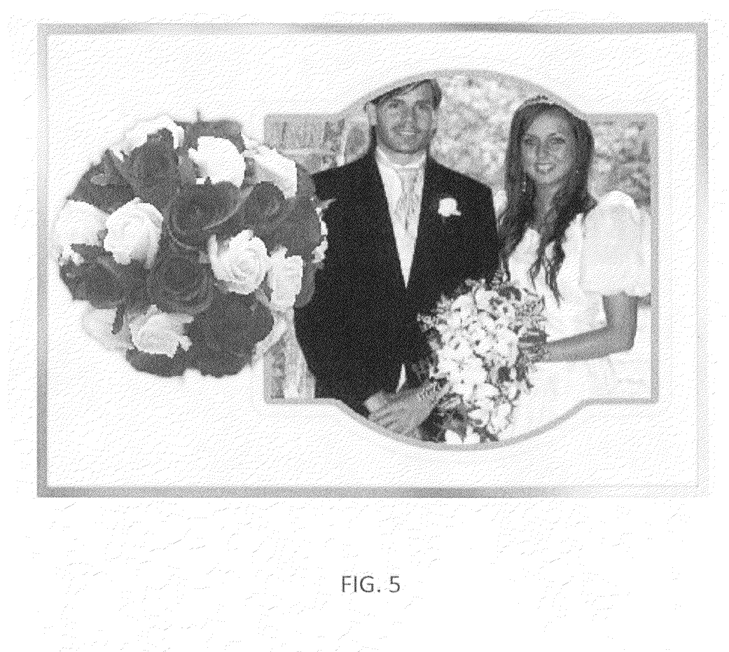

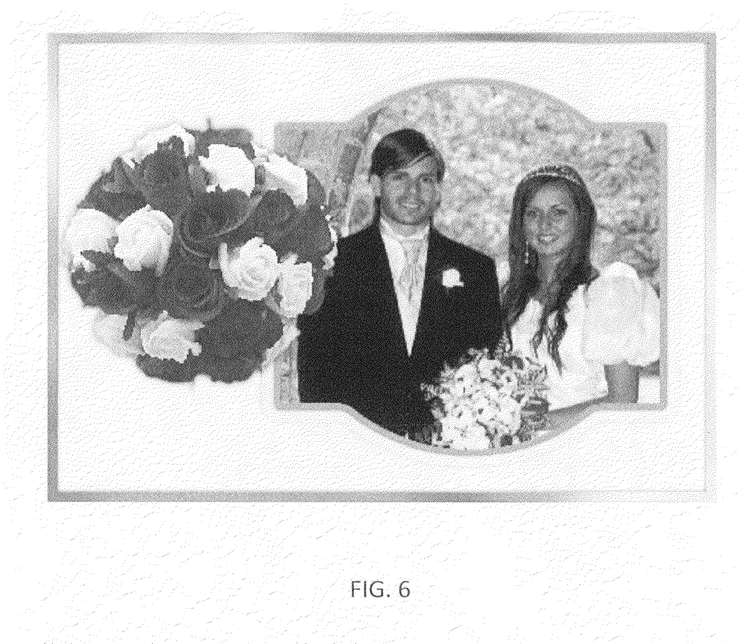

FIG. 4 is a sample greeting card template presented in gray scale utilized to illustrate the processes and sub-processes of the exemplary embodiments disclosed herein. The checkered area of FIG. 4 is the intended target area for the final personalized presentation. Continuing with the embodiment above, the image in FIG. 3 and the template in FIG. 4 may be selected to create the personalized presentation. As mentioned before, the salient region of the image may be any portion of the image, but for example, the male and the female with the flowers, may be selected as the salient regions. The selection of the salient region may be defined by user selection (for example by utilizing a computer to select the region or regions) or may be selected by systems, processes or methods created for locating salient regions. The desired location within the target area of the template may also need to be determined, partly because the target areas generally are not uniform shapes, but rather not-uniform and contorted. The determination of the desired location may be defined by user selection (for example by utilizing a computer to select the regions) or may be selected by systems, processes or methods created for determining the desired location. Utilizing existing methods for composing the image in FIG. 3 into the target area of the template in FIG. 4, results in improper composition of the image within the template. FIG. 5 is a sample improper composition of the image in FIG. 3 into the target area of the template in FIG. 4. The proper composition of the image and template are reflected in FIG. 6.

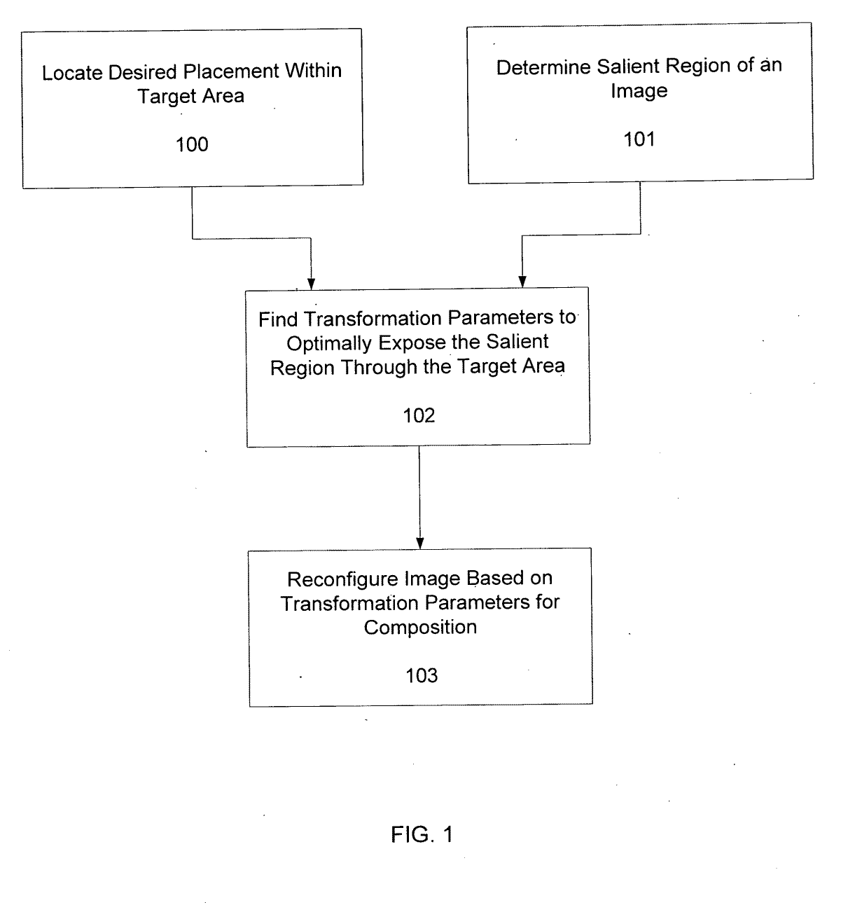

FIG. 1 is a diagrammatic illustration of a system, process or method for retargeting an image utilizing a saliency map, according to one embodiment. In this embodiment, the desired placement within the target area is located at 100. The salient region of an image is defined or determined at 101. Transformation parameters to optimally expose the image with the salient region in the target area are found at 102. The image is then reconfigured for composition based on the transformation parameters at 103.

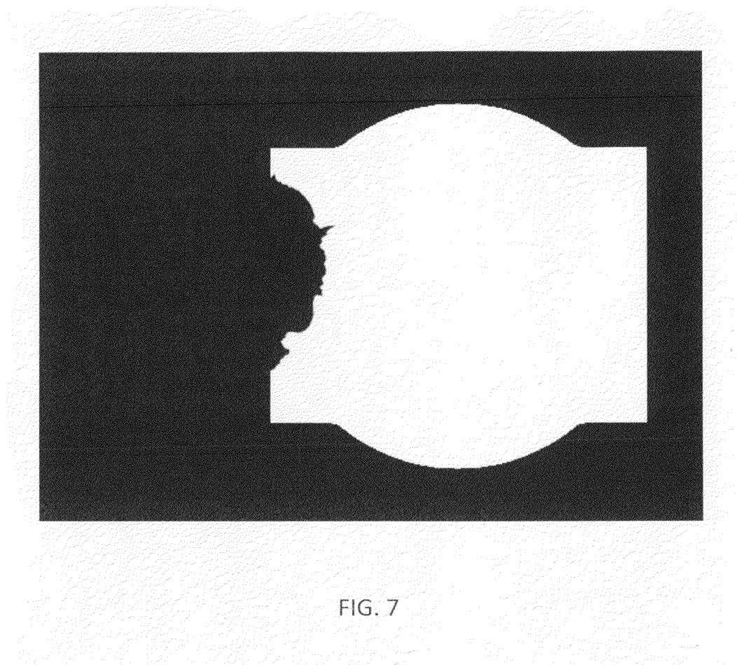

The desired placement or location determination, as mentioned above, operation is optional and can comprise any conventional type of determination operation, such as allowing a user to select the desired location within the target area. In an alternative embodiment, a position bias map may be utilized to determine the desired placement. For example, let α_{c}(x, y) denote the transparency map for the target region or cut-out region. It may be defined by zero outside the cut-out region and takes a value from 0 to 1 otherwise. It may be mostly 1, except near the boundaries of the cut out region, where the transparency map may take intermediate values for anti-aliasing. FIG. 7 is a sample transparency map created from the sample greeting card template in FIG. 4.

The position bias map may be utilized for the following, but not limiting, benefits: to encourage the centroid of the salient region to be positioned at a desired location inside the target area; and to discourage the salient regions from being outside the target area. To do so, in one alternative embodiment, the position bias map is denoted as p_{c}(x, y) based on α_{c}(x, y). Then bias terms bₕ(x, y) and bᵥ(x, y) are introduced to encourage the position bias map to be at a desired location.

bₕ(x, y) is the bias for the horizontal positioning as defined below:

$${b}_{h} ( x , y ) = exp ( - \vert x - {μ}_{h} \vert / {σ}_{h} )$$

$$where$$

$${μ}_{h} = \frac{{\int }_{x} x \cdot ( {\int }_{y} {α}_{c} ( x , y ) d y ) d x}{{\int }_{x} {α}_{c} ( x , y ) d x}$$

$$σ = max ( {max}_{i} ( {h}_{i} ) , {max}_{i} ( {w}_{i} ) )$$

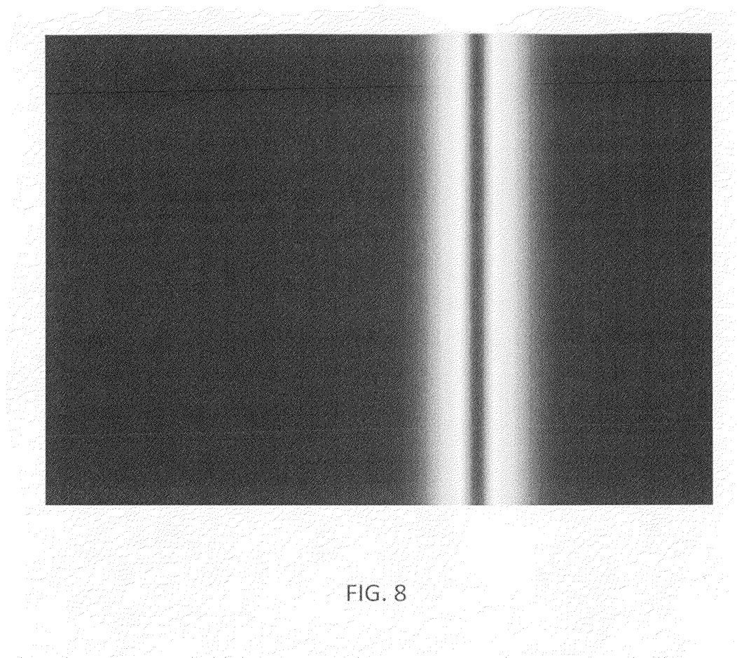

Note that μₕ is the x-coordinate of the centroid of α_{c}(x, y). FIG. 8 is an illustration in gray scale for the horizontal bias term of the target area within the sample greeting card template in FIG. 4.

bᵥ(x, y) is the bias for vertical positioning as defined below:

$${b}_{v} ( x , y ) = exp ( - \vert y - {μ}_{v} \vert / σ )$$

$$where$$

$${μ}_{v} = {inf}_{y} \vert {\int }_{- ∞}^{y} ( {\int }_{x} {α}_{c} ( x , y ) d x ) d y - \frac{1}{3} \cdot {\int \int }_{x , y} {α}_{c} ( x , y ) d x \cdot d y \vert$$

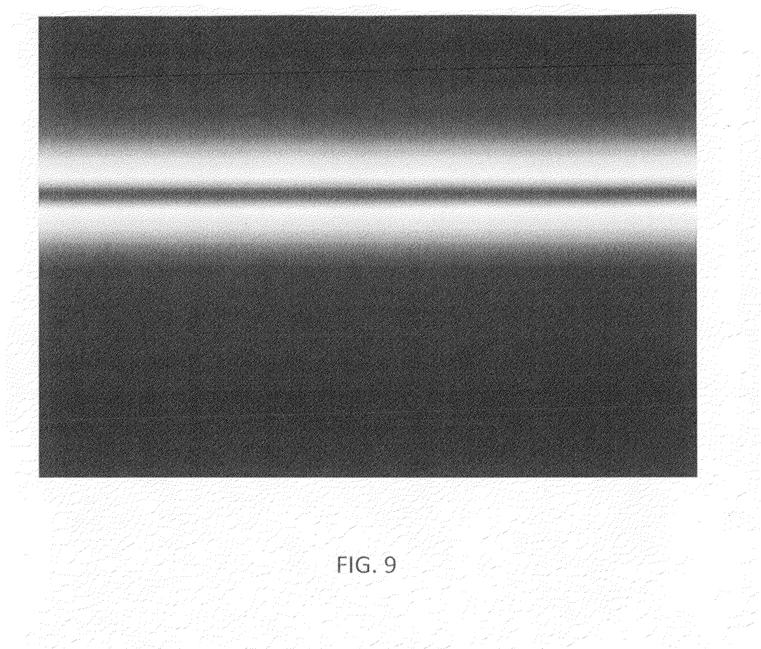

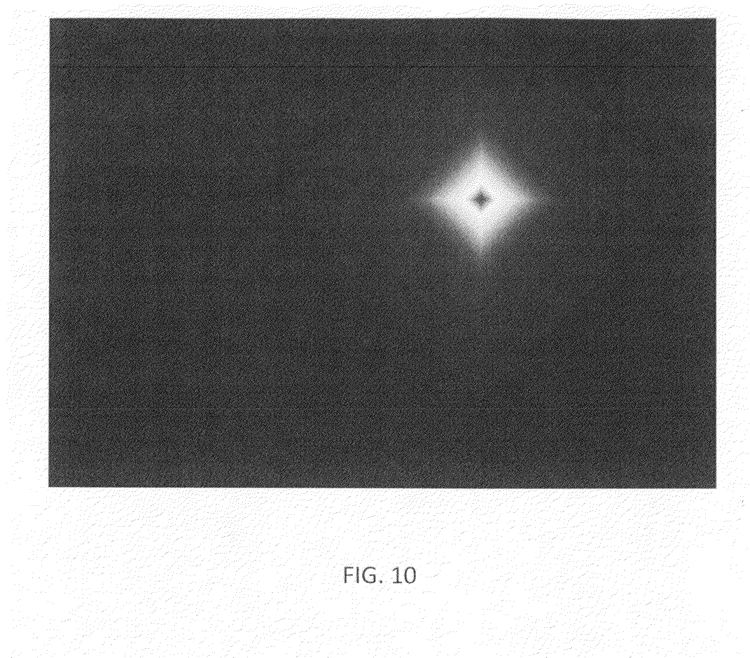

Note that in the above definition, y increases downwards (applying to, for example, image coordinates) and −∞ corresponds to the first row of α_{c}(x, y)·bᵥ(x, y) is roughly the first row of the transparency map α_{c}(x, y) for which the cumulative row sum from the top row is about a third of the sum of all values in α_{c}(x, y). FIG. 9 is an illustration in gray scale for the vertical bias term of the target area within the sample greeting card template in FIG. 4. FIG. 10 is an illustration in gray scale of the effective bias term from contribution by the product of the horizontal bias term of FIG. 8 and the vertical bias term of FIG. 9.

The position bias map p_{c}(x, y) may be defined as bₕ(x, y)·bᵥ(x, y)·α_{c}(x, y) inside the target region and −γ_{c} otherwise. This is summarized as follows:

$${p}_{c} ( x , y ) = \{ \begin{matrix}{b}_{h} ( x , y ) \cdot {b}_{v} ( x , y ) \cdot {α}_{c} ( x , y ) , & when {α}_{c} ( x , y ) > 0 \\ - {γ}_{c} , & otherwise\end{matrix}$$

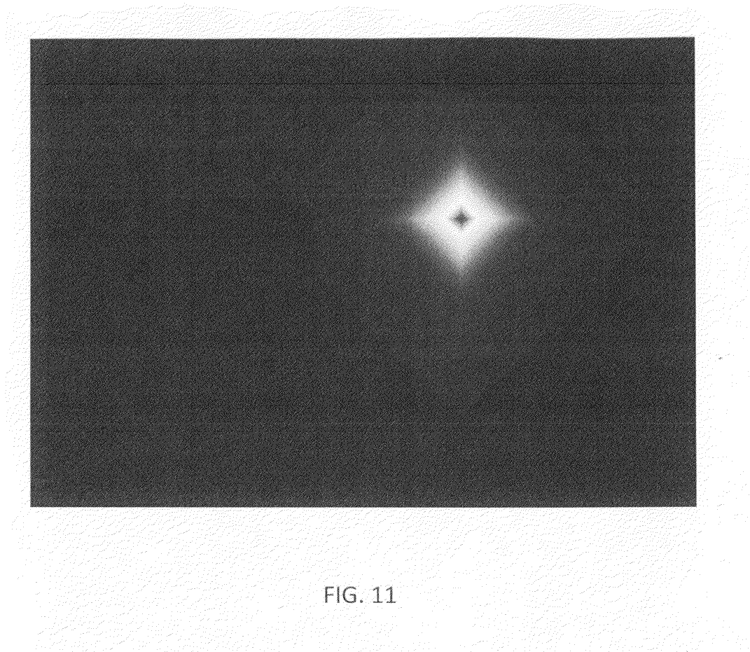

FIG. 11 is an illustration in gray scale of the effective bias term when γ_{c}=0. Better results may be achieved when γ_{c}<0. In one embodiment, the transparency map may be scaled down so that the maximum number of pixels along the longest edge is a set number of pixels (for example, 128 pixels). A scaled down version of α_{c}(x, y) may be utilized for better speed during the optimization step to find the best transformation parameters for T as explained below.

The salient region of an image is defined or determined at 101. As explained above, the locating, defining or determining of the salient region of an image operation can comprise any conventional type of locating, defining or determining operation, such as allowing a user to select or identify the salient region. In an additional embodiment, a saliency map may be utilized to define the salient region. In an additional alternative embodiment, a saliency map may be created by utilizing image detectors for a number of different types of subjects. For example, the salient region of an image may be humans, animals, cars, nature, or the like. For example, for images with pets, a pet detector may be utilized, such as the one disclosed in “Machine Learning Attacks Against the Asirra CAPTCHA”, Philippe Golle, Conference on Computer and Communications Security, Proceedings of the 15th ACM conference on Computer and communications security, ISBN: 978-1-59593-810-7, pp. 535-542, 2008, which is hereby incorporated by reference in its entirety for this purpose. Another example for a number of different subjects, saliency may be derived from processes disclosed in “Frequency-tuned Salient Region Detection”, R. Achanta, S. Hemami, F. Estrada, S. Susstrunk, CVPR 2009, which is hereby incorporated by reference in its entirety for this purpose.

Commonly, the salient portion of an image revolves around humans. In one embodiment, a salient portion of an image may be the human faces, which may be utilized to determine the overall salient region. For such types of image, a face detector may be utilized to derive a saliency map. For example, “High-Performance Rotation Invariant Multiview Face Detection”, C. Huang, H. Ai, Y. Li, S. Lao, IEEE Transactions on Pattern Analysis and Machine Intelligence (PAMI), pp. 671-686, Vol. 29, No. 4, April 2007, discloses a number of face detectors and is hereby incorporated by reference in its entirety for this purpose.

In another alternative embodiment, an assumption may be that the human face has higher saliency than the human body. Such an assumption is evidenced by “Gaze-Based Interaction for Semi-Automatic Photo Cropping”, A. Santella, M. Agrawala, D. DeCarlo, S. Salesin, M. Cohen, ACM Human Factors in Computing Systems (CHI), pp. 771-780, 2006, which is hereby incorporated by reference in its entirety.

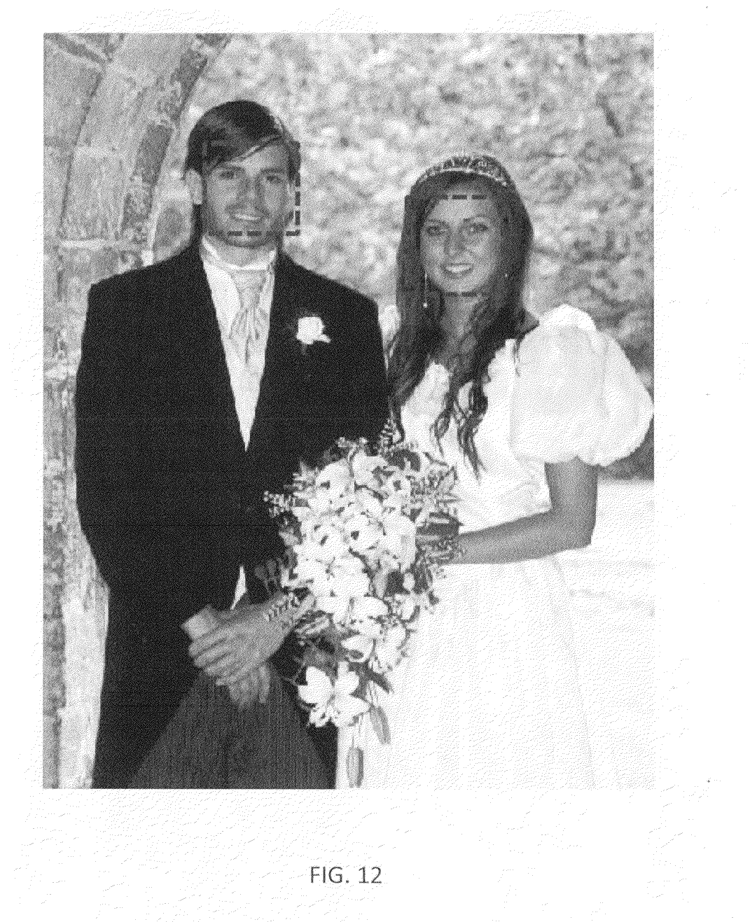

A saliency map may contain values between 0 and 1 for non-salient regions and salient regions respectively. Utilizing an assumption that the human face is a significantly salient portion of the image, we may further assume that a face detector returns a rectangle FaceRectᵢ for each face i of height hᵢ and width wᵢ. FIG. 12 is the sample image in FIG. 3 with face rectangles over the two faces. A rough representation may be made for the top of the body by a rectangle of height hᵢ^{s} and width wᵢ^{s} (herein also referred to as “BodyRectᵢ”). hᵢ^{s}, wᵢ^{s} may be chosen as factors of hᵢ, wᵢ respectively. In some embodiments hᵢ^{s}=βhᵢ and wᵢ^{s}=3.5wᵢ, where βε[0.5,1.5] may be used. To allow for variations in hair styles and head gear, the face rectangles may be scaled by, for example, 1.5.

The salient region may be defined as Rᵢ^{s}. The value that are outside FaceRectᵢ ∪ BodyRectᵢ may be 0. With multiple faces, the effective salient region Rₛ could be defined by the union of Rᵢ^{s}

$${R}_{s} = {{⋃}^{\# faces}}_{i = 1} {R}_{i}^{s}$$

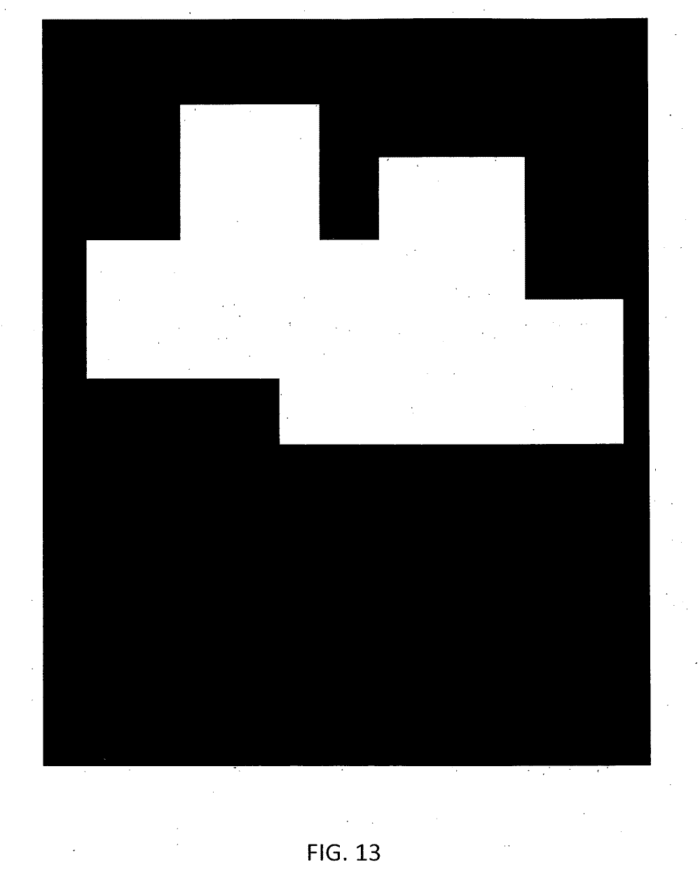

FIG. 13 is an illustration of the salient region Rₛ from the sample image in FIG. 3. In one embodiment, the salient region may itself serve as a saliency map.

The saliency map may be defined as S_{I}(x,y) as the saliency map for image I(x,y). Assuming the face has been selected as the most salient region, the maximum value of 1 can be assigned to pixels inside the face rectangle, or the scaled face rectangle. With this assumption, the indirect assumption made is that the body in the salient region is not as salient as the face. Letting S_{I, i}(x,y) be the contribution from face i. S_{I}(x,y) is taken to be the sum of S_{I,i}(x,y) for all faces. The maximum value of S_{I}(x,y) is restricted to 1.

$${S}_{I} = ( x , y ) = min ( 1 , {\sum }_{i = 1}^{\# faces} {S}_{I , i} ( x , y ) )$$

The saliency of body below face should decrease away from the bottom of face (based on the indirect assumption). To do so, define dᵢ(x, y) as Euclidean distance of any point (x, y) from the mid-point of the bottom edge of FaceRectᵢ. This is summarized by the following equation:

$${S}_{I , i} ( x , y ) = \{ \begin{matrix}1 , & ( x , y ) ∈ {FaceRect}_{i} \\ {d}_{i} ( x , y ) , & ( x , y ) ∈ {BodyRect}_{i} \\ 0 , & otherwise\end{matrix}$$

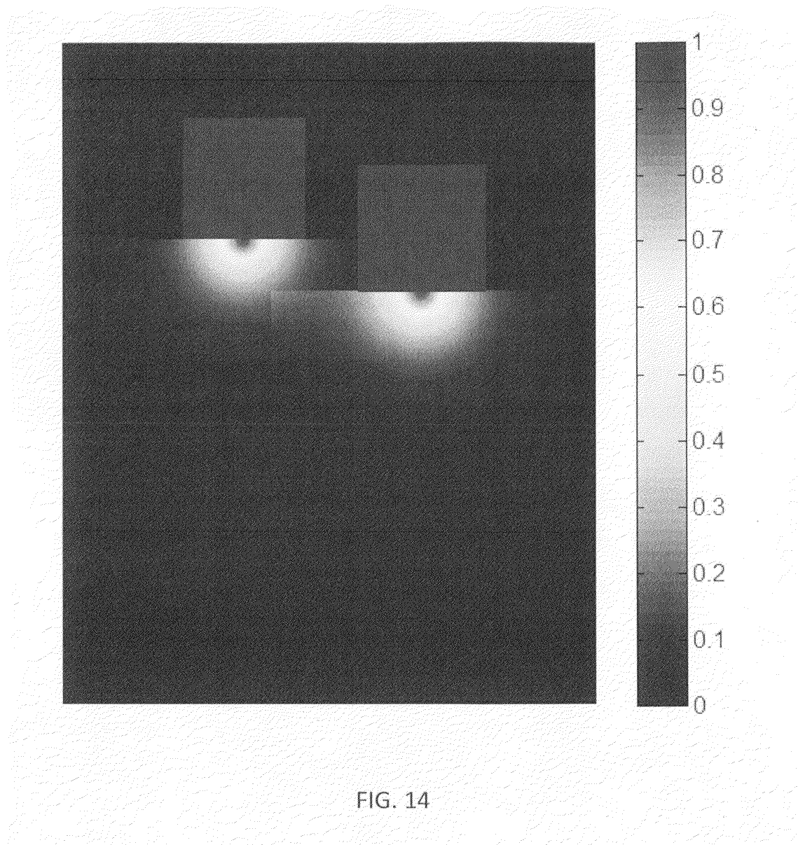

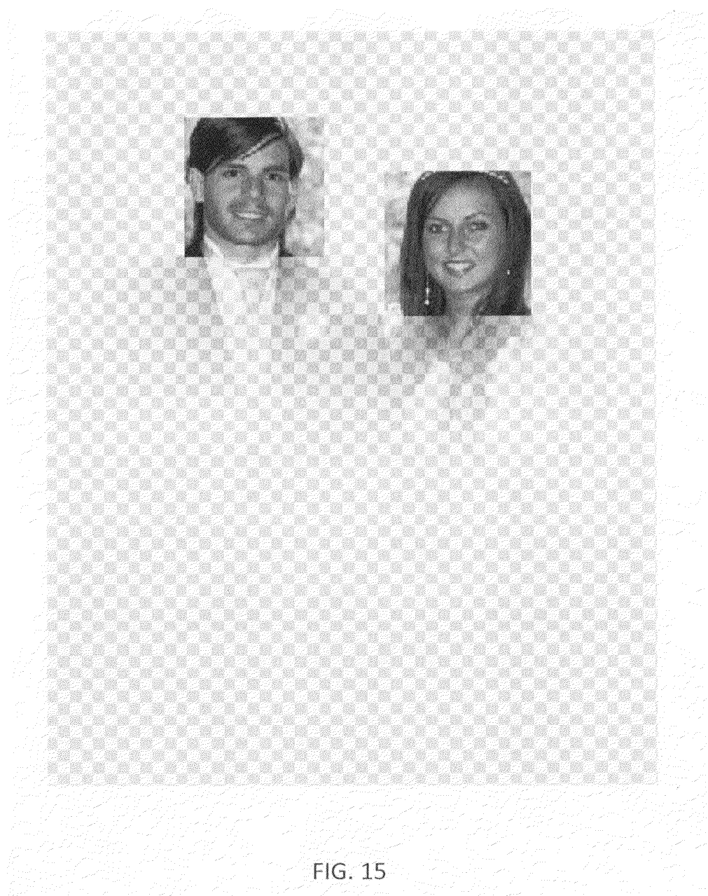

FIG. 14 is an illustration of the overall saliency map created from the assumption that the face portion of the salient region Rₛ has a higher saliency than the rest of the region. FIG. 15 is the overall saliency map illustrated in FIG. 14 with the input image's transparency controlled by the saliency map.

As should be evident, the utilization of the human face as a higher salient feature of an image than other features or portions of the image is only one embodiment of the inventive concepts disclosed. The same embodiment or related embodiments also performed steps or actions based upon assumptions that apply for those embodiments. However, the operation may utilize any portion of an image that is disclosed, discovered, or otherwise selected as the portion of choice. Thus, though this disclosure refers to the “salient” region, any portion of the image may be chosen—the decision in determining the salient portion of an image can be a subjective exercise. Further, if assumptions are chosen to be made, they may be completely different based upon the operation selected for defining the salient region. Further, as mentioned above, data or information about the salient region may be utilized to define a saliency map directly. The saliency map may also be user created.

If the salient portion of an image was a segmentation from the rest of the image, the data from the segmented portion may be utilized to further emphasize the salient region. The information may lead to the creation of a better composition. Further, a segmentation mask may used to modify a saliency map. For example, utilizing the result of multiplying the saliency map with the segmentation mask would lead to more emphasis of the salient region for later operations. The creation of a segmentation mask can comprise any conventional type of segmentation mask creation, including the approach proposed in Patent Cooperation Treaty Patent Application No. PCT/US2008/013674 entitled “Systems and Methods for Rule-Based Segmentation for Vertical Person of People with Full or Partial Frontal View in Color Images,” filed Dec. 12, 2008, which is hereby incorporated by reference herein in its entirety.

Transformation parameters to optimally expose the image with the salient region in the target area are found at 102. Composition of an image inside a cut-out template or target region may have an infinite number of possible solutions. Consider the case where the center of input image is aligned with the centroid of cut-out region. This defines the parameter for offset, namely t=[tₓ, t_{y}]. However, there may be a minimum scale beyond which the image will always fully cover the cut-out region. Let s denote scale. Define T to be the transformation to be applied to image I before composition. The transformed image may then be denoted as T(I(x,y)) or T(I) in short and the saliency map for transformed image may be denoted as S_{T(I)}(x,y) or S_{T} in short. In some embodiments, composition quality should be defined in such a way that the quality is high when all salient regions are visible through the cut-out as large as possible, or in other words, the smallest scale for which all salient regions are visible in the composed image. Quality may be low when highly salient regions are outside the cut-out region. The following definition of composition quality for transformation T and cut-out transparency α_{c}(x, y) may be utilized:

$${q}_{α , T} := {q}_{a} ( s , t ) = \frac{1}{{s}^{2}} {\int \int }_{x , y} {p}_{c} ( x , y ) \cdot {S}_{T} ( x , y ) d x \cdot d y$$

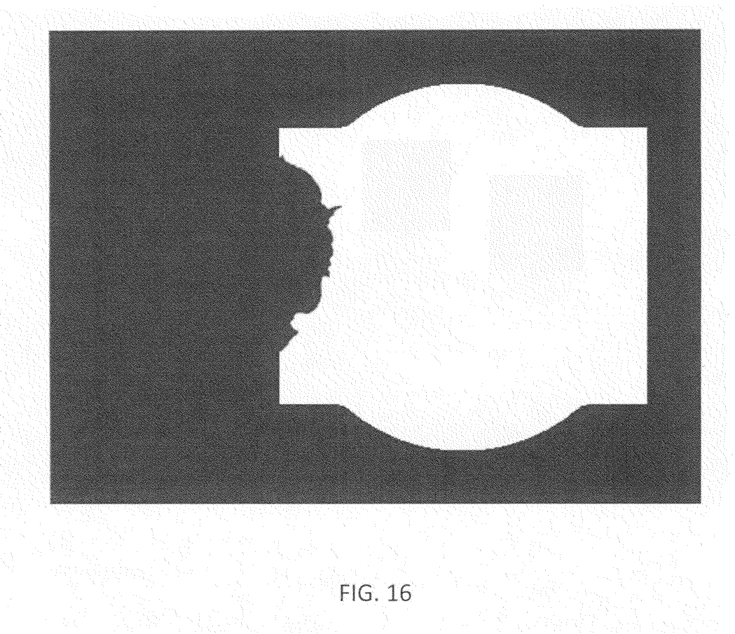

The image I is scaled up when s>1 and scaled down when s<1. The denominator s² is optionally introduced to discourage image I to be scaled up. The value of the integral is higher when the salient regions are as large as possible inside the cut-out region. Composition quality q_{α,T} can be evaluated by overlapping α_{c}(x, y) or p_{c}(x, y) and S_{T}(x, y). FIG. 16 is an illustration in gray scale of the transformed saliency map S_{T(I)}(x,y) overlapped with the target region transparency α_{c}(x, y).

Transformation T (of image I) may restrict offset t and scale s. In one embodiment, the operation may include flip and rotation. T* may represent the optimal transformation and consists of the best offset t* and best scale s*.

$${T}^{*} := [ {s}^{*} , {t}^{*} ] = arg {max}_{s , t} {q}_{α} ( s , t )$$

Standard techniques such as gradient based methods can be used to find a solution to the above equation. Note that evaluation of q_{α,T} may be expensive even when α_{c}(x, y) is scaled down as mentioned earlier. For a given scale, the concept of integral image for speed may be utilized, such as that described in, “Rapid object detection using a boosted cascade of simple features”, P. Viola, M. J. Jones, Proceedings of Computer Vision and Pattern recognition, vol. 1, pp. 511-518, 2001 which utilizes integral image to make face detection feasible in real-time and is hereby incorporated by reference in its entirety. The integral image operation is also utilized in “Summed-Area Tables for Texture Mapping”, Franklin C. Crow, Intl. Conf. on Computer Graphics and Interactive Techniques, pp. 207-212, 1984, which is hereby incorporated by reference in its entirety. The integral image is an image where each pixel takes the cumulative value of pixels in the rectangle above, whose diagonal vertices are the top-left pixel and the current pixel in integral image. Using an integral image, the area of any rectangle in the image can be evaluated.

A crop-safe rectangle may be defined as the smallest rectangle that captures the salient regions in image I. For optimization, the goal may be defined to find the transformed rectangle with maximum area inside the crop-safe region. In order to use the position map, integral image of p_{c}(x, y) is used. Integral image of p_{c}(x, y) may be pre-calculated for the scaled α_{c}(x, y). The aspect ratio of transformed crop-safe rectangle may be fixed during optimization. The area inside this rectangle inside the crop-safe region is treated as an approximation for composition quality q_{α,T}. For more accuracy, S_{T} may be treated as a union of rectangles. Note that a standard global optimization approach can be used to find the best scale and offset for the simplified composition quality.

As noted above, optionally, height of body hᵢ^{s}=βhᵢ, where βε[0.5,1.5]. The optimal value of β may be found by utilizing a binary search. Given that some images may not contain enough of the body, this limits the maximum value of β to less than 1.5 for some images.

The image is then reconfigured for composition based on the transformation parameters at 103. In one embodiment, the image may be reconfigured by defining I_{Front}(x, y) or I_{Front} to be the RGB image for the front layer. Transparency map α_{c}(x, y) defines the cut-out region for the image. The composed image may be defined as I_{Comp}(x, y) or I_{Comp}. By utilizing a determined scale and offset, the following equation may be utilized:

I_{Comp}(x,y)=[1−α_{c}(x,y)]·I_{Front}(x,y)+α_{c}(x,y)·T(I)(x,y)

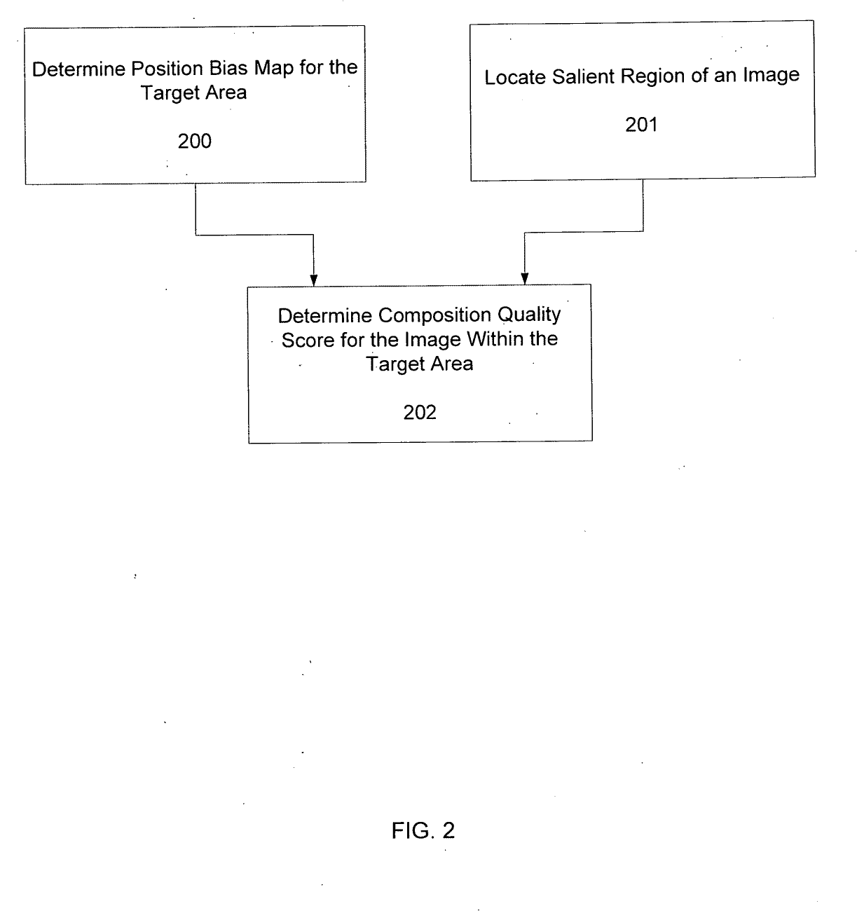

FIG. 2 is a diagrammatic illustration of a system, process or method for sorting target areas within templates for an image, according to another embodiment. A position bias map for the target area is determined at 200. The salient region of an image is located at 101. The composition quality for the image within the target area is determined at 202. The composition quality evaluation operation may be conducted by the operation described above. This operation allows for the sorting of several templates for a given image. In an alternative embodiment, only thumbnails of top templates may be downloaded onto a user's workspace, thereby reducing the amount of data transfer.

According to one embodiment of the present disclosure, the aspect ratio of an image may be changed while maintaining the salient regions of the image properly. An image may be safely cropped by realizing that the target region is likely always a rectangle and the scale s is set to 1. Optionally, a saliency map may be utilized. Based on the goal aspect ratio, the image may be cropped symmetrically to the left and right of the salient region. In cases where there are more than one salient regions identified, for example two face rectangles, the image may be cropped symmetrically to the left of the left-most face rectangle and the right of the right-most face rectangle. If any of the salient portions are at risk then, the user may be notified or may determine another approach. For example, for the sample image in FIG. 3, the salient region Rₛ as illustrated in FIG. 13 may be utilized as a mapping of the salient region. For this embodiment, the transparency map for the target region will likely be a rectangle with the desired aspect ratio dimensions, that is all the pixels may be set to unity (i.e.) a white rectangle of desired dimensions for printing. In an alternative embodiment, the operation for a position bias map will not need to be performed. This is equivalent to using p_{c}(x,y)=1.

The quality factor may be expressed as follows:

$${q}_{α , T} := {q}_{α} ( t ) = {\int \int }_{x , y} {S}_{T} ( x , y ) d x \cdot d y$$

It will be apparent to a person skilled in the art that though some embodiments disclosed included templates where there is a cut-out region surrounded by a occlusion region, that other templates where there is an occlusion region surrounded by a cut-out region can also be processed.

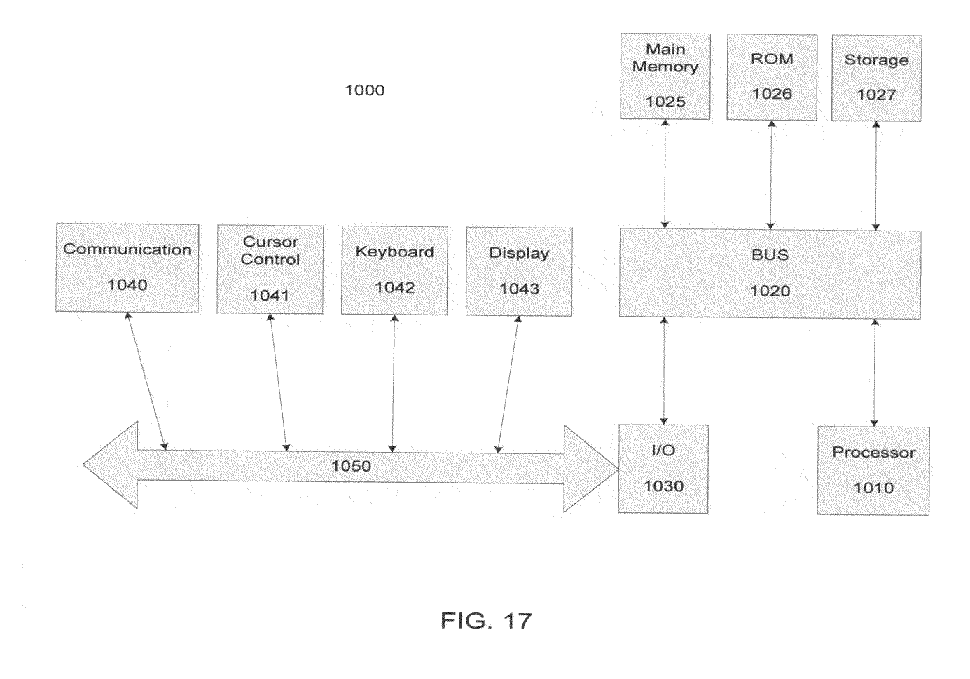

As desired, the methods disclosed herein may be executable on a conventional general-purpose computer (or microprocessor) system. Additionally, or alternatively, the methods disclosed herein may be stored on a conventional storage medium for subsequent execution via the general-purpose computer. FIG. 17 is an illustration of an exemplary embodiment of an architecture 1000 of a computer system suitable for executing the methods disclosed herein. Computer architecture 1000 is used to implement the computer systems or image processing systems described in various embodiments of the method for segmentation. As shown in FIG. 17, the architecture 1000 comprises a system bus 1020 for communicating information, and a processor 1010 coupled to bus 1020 for processing information. Architecture 1000 further comprises a random access memory (RAM) or other dynamic storage device 1025 (referred to herein as main memory), coupled to bus 1020 for storing information and instructions to be executed by processor 1010. Main memory 1025 is used to store temporary variables or other intermediate information during execution of instructions by processor 1010. Architecture 1000 includes a read only memory (ROM) and/or other static storage device 1026 coupled to bus 1020 for storing static information and instructions used by processor 1010. Although the architecture 1000 is shown and described as having selected system elements for purposes of illustration only, it will be appreciated that the method for refinement of segmentation using spray paint markup can be executed by any conventional type of computer architecture without limitation.

A data storage device 1027 such as a magnetic disk or optical disk and its corresponding drive is coupled to computer system 1000 for storing information and instructions. The data storage device 1027, for example, can comprise the storage medium for storing the method for segmentation for subsequent execution by the processor 1010. Although the data storage device 1027 is described as being magnetic disk or optical disk for purposes of illustration only, the methods disclosed herein can be stored on any conventional type of storage media without limitation.

Architecture 1000 is coupled to a second I/O bus 1050 via an I/O interface 1030. A plurality of I/O devices may be coupled to I/O bus 1050, including a display device 1043, an input device (e.g., an alphanumeric input device 1042 and/or a cursor control device 1041).

The communication device 1040 is for accessing other computers (servers or clients) via a network. The communication device 1040 may comprise a modem, a network interface card, a wireless network interface, or other well known interface device, such as those used for coupling to Ethernet, token ring, or other types of networks.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this detailed description, but rather by the claims following.

What is claimed is:

1. A method for retargeting an image utilizing the image's salient region comprising:
a. locating a desired placement within a target area;
b. determining the salient region of the image;
c. finding one or more transformation parameters to optimally expose the salient region in the target area; and
d. reconfiguring the image based on transformation parameters.

2. A computer system comprising:
a processor; and
a memory, the memory including one or more modules, the one or more modules collectively or individually comprising instructions for carrying out the method of claim 1.

3. A computer program product for use in conjunction with a computer system, the computer program product comprising a computer readable storage medium and a computer program mechanism embedded therein, the computer program mechanism comprising instructions for carrying out the method of claim 1.
